(19) United States
(12) Patent Application Publication
(10) Pub. No.: US 2007/0040065 A1
(43) Pub. Date: Feb. 22, 2007

(54) Flexible refueling boom extendable tube

(76) Inventor: German Von Thal, Santa Maria, CA (US)

Correspondence Address: HARNESS, DICKEY & PIERCE, P.L.C., P.O. BOX 828, BLOOMFIELD HILLS, MI, 48303, US

(21) Appl. No.: 11/208,343

(22) Filed: Aug. 19, 2005

(51) Int. Cl. B64D 39/00

(52) U.S. Cl. 244/135 A

(57) ABSTRACT

A tanker aircraft refueling boom utilizes an upper boom tube that connects to an aircraft fuselage, a lower boom tube that connects to the upper refueling tube, and a removable flexible tube with a nozzle that is connected to the lower boom tube. The flexible tube is bendable to accommodate movement of the tanker aircraft relative to the receiver aircraft during refueling. The flexible tube is expandable to absorb shock loads due to the conservation of momentum of the fuel when the fuel is shut off during delivery. The expandable flexible tube eliminates shock loads in other areas of the refueling boom. A ruddevator is attached to the refueling boom to permit aerial control of the upper, lower and flexible tubes prior to and during refueling. The flexible tube is independently removable from the refueling boom to facilitate convenient and cost-effective maintenance.

### FIELD OF THE INVENTION

The present invention relates to an airborne mobile platform refueling boom having a flexible, pressure responsive end tube.

### BACKGROUND OF THE INVENTION

Aircraft refueling booms are well known in the art; however, each is associated with its share of limitations. For instance, FIG. 1 depicts a tail section of the aircraft 20 equipped with an extendible rigid aircraft refueling boom 10 that suffers from several limitations. For instance, when the nozzle 80 of the rigid refueling boom 10 is positioned using the control vanes 50, the refueling boom 10 can withstand only a limited amount of in-flight movement during the actual refueling process when the nozzle 80 resides within a receiver aircraft (not shown). If such movement occurs when the nozzle 80 is in the receiver aircraft, the refueling boom 10 may undergo undesirable stress at any of a multitude of boom locations such as at the point where the boom upper section 30 meets the aircraft 20, where the retractable boom portion 70 retracts into the boom lower section 60, or where the nozzle 80 inserts into a receiver aircraft (not shown). Regardless of whether such in-flight movement is vertical or horizontal, the refueling boom 10 may undergo undesirable stress at the noted locations. If boom overstressing occurs, repairing the boom requires removal of the complete refueling boom 10 from the aircraft 20.

While overstressing of the boom may result while physically manipulating the boom during a refueling event, damage of the boom at the conclusion of refueling may also occur due to a fluid shock load. More specifically, if the maximum refueling pressure of the refueling boom is exceeded, then the boom may suffer the effects of “water-hammer” during receiver aircraft refueling. In order to lessen the effects of water-hammer, an internal fuel dynamic shock absorber bladder 40 is typically required in existing refueling booms. However, repairing and replacing such a bladder 40 is time consuming and expensive because removal of the entire refueling boom 10 is required for such a repair. Additionally, replacement or repair of the bladder 40 also results in the aircraft being out of service for an extended period of time since extensive repair hours are generally necessary. This aircraft downtime increases the overall cost of repair of the bladder 40 and the life-cycle cost of the refueling boom.

A need exists then for an aircraft refueling boom that does not suffer from the above limitations. This in turn, will result in a flexible aircraft refueling boom portion that is capable of accepting horizontal and vertical movements without subjecting the refueling boom to stressful loads during in-flight refueling maneuvering; a boom tube that is capable of expanding and absorbing shock loads attributable to fuel momentum pressure build up due to abrupt fuel starts and shut-offs to a receiver aircraft; a boom tube portion that can be quickly and easily removed from the aircraft and either repaired or replaced resulting in decreased aircraft downtime compared to existing refueling booms.

### SUMMARY OF THE INVENTION

An airborne mobile platform refueling boom is disclosed. The refueling boom is typically used in connection with a refueling tanker aircraft, although the refueling boom could be employed with any form of refueling mobile platform, and is therefore not limited to use with just aircraft. In one embodiment the refueling boom utilizes an upper boom tube that connects to an aircraft underside, a lower boom tube that connects to the upper boom tube, and a removable flexible tube with a nozzle that is connected to the lower boom tube. The flexible tube is bendable to accommodate movement of the tanker aircraft relative to a receiver mobile aircraft during in-flight refueling of the receiver aircraft. Also, when the flexible tube bends, it signifies to a boom operator that the flexible tube is under a stress load. The flexible tube is also expandable about its longitudinal axis to absorb loading forces due to the conservation of momentum of the fuel being shut off or on during a refueling event. The expandable, flexible tube eliminates shock loads and pressure spikes in other areas of the refueling boom due to the expandability of the flexible tube.

A ruddervator is attached to the refueling boom to permit aerial control of the upper, lower and flexible tubes prior to and during refueling. The flexible tube is individually removable from the refueling boom, without removing the balance of the boom from the aircraft, to facilitate convenient and cost-effective maintenance. The removal of the flexible tube may be by a threaded connection, a push-on pull-off type connection, or other suitable mechanical quick disconnect method. In another embodiment, the entire refueling boom tube is either a rigid tube or a flexible, bendable hose with an additional end hose or tube that is expandable, resilient and equipped to be quickly connected and disconnected to the main refueling boom tube. A flexible, bendable and expandable tube eliminates the need for an internal shock bladder of prior art refueling booms.

The features, functions, and advantages can be achieved independently in various embodiments of the present invention or may be combined in yet other embodiments.

### BRIEF DESCRIPTION OF THE DRAWINGS

The present invention will become more fully understood from the detailed description and the accompanying drawings, wherein:

FIG. 1 is a perspective view of an aircraft tail section employing a rigid refueling boom with an internal shock bladder, according to the prior art;

FIG. 2 is a perspective view of an aircraft tail section employing a refueling boom with a flexible extendable air refueling boom tube according to the teachings of the present invention;

FIG. 3 is a perspective view of a refueling boom with a flexible, expandable, and extendable air refueling boom end tube according to the teachings of the present invention;

FIG. 4 is a perspective view of a flexible, expandable air refueling boom end tube according to the teachings of the present invention;

FIG. 5 is a perspective view of a flexible, expandable air refueling boom end tube in an expanded condition according to the teachings of the present invention;

FIG. 6 is a perspective view of a flexible boom tube having a flexible, expandable air refueling boom end tube according to a second embodiment of the teachings of the present invention; and

FIG. 7 is a perspective view of a basket style fuel receptacle to which the flexible air refueling boom tube of the present invention can be applied.

### DETAILED DESCRIPTION OF THE PREFERRED EMBODIMENTS

The following description of various preferred embodiments is merely exemplary in nature and is in no way intended to limit the invention, its application, or uses.

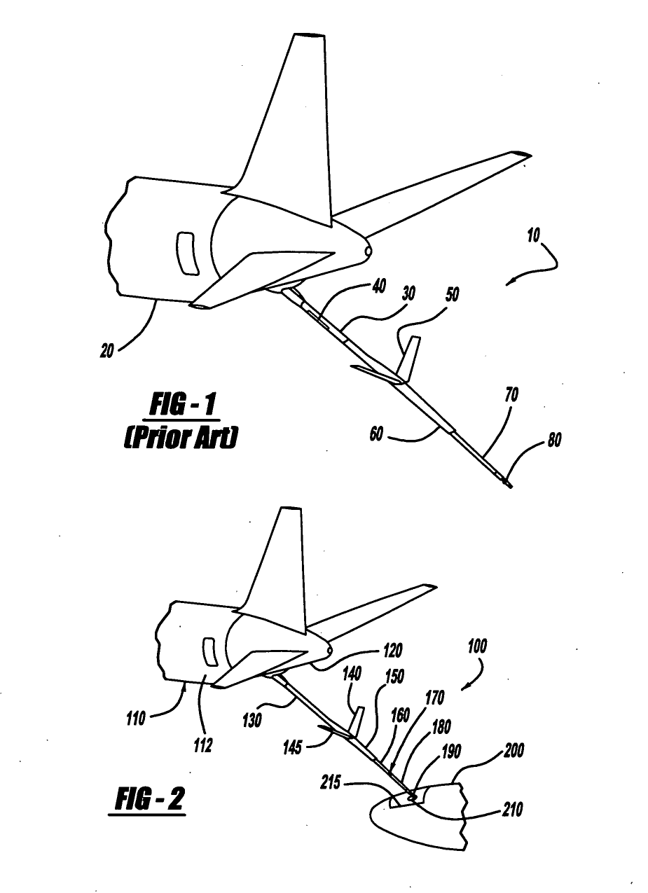

An in-flight refueling boom according to the teachings of the present invention is generally depicted in FIG. 2 at reference numeral 100. A first end of the refueling boom 100 attaches to a tanker aircraft 110, usually at the aircraft tail section 120. The connection of the refueling boom 100 to the tanker aircraft 110 is normally a rigid connection that permits movement in the vertical direction, that is, a vertical plane through which the refueling boom 100 can move or pivot.

In an in-flight refueling operation, the refueling boom 100 is moved, known as “flying” the boom, by an operator, known as a “boomer”, in a vertical plane by manipulating control vanes 140, 145, referred to throughout the following discussion as “ruddervators” 140, 145. The control vanes 140, 145 are termed “ruddervators” 140, 145 because they act as a rudder and an elevator for maneuvering the refueling boom 100 when the refueling boom 100 is maneuvered into position over a receiver mobile platform, such as a receiver aircraft 200.

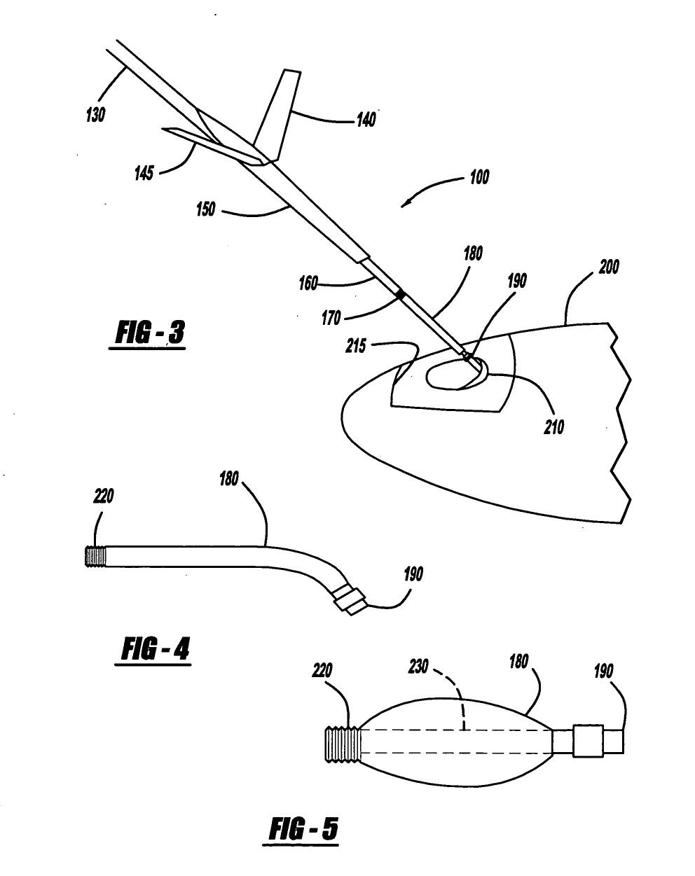

Continuing with the description of the refueling boom 100, FIG. 2 and FIG. 3 depict a main refueling tube 130 that is attached to the tanker aircraft 110. On the main refueling tube 130 are the attached ruddervators 140, 145, which are used to maneuver the refueling boom 100 into position for refueling the receiver aircraft 200. Although the refueling boom 100 is easily maneuvered in a vertical plane, the refueling boom can also be maneuvered laterally to a small degree.

Continuing with reference to FIGS. 2 through 5, in operation, the refueling boom 100 is supported from a fuselage 112 of the tanker aircraft 110 and maneuvered over a receiver aircraft 200 so that the receiver aircraft 200 can receive liquid fuel from the supply or tanker aircraft 110. Just before refueling, the refueling boom 100 is positioned over, yet slightly in front of, the receiver aircraft 200 using the ruddervators 140, 145. As this event occurs, the retractable refueling tube 160 may be extended from within a distal end of the main refueling tube 130, relative to the tanker aircraft 110. The rigid retractable refueling tube 160 has a connection portion 170 that is used to connect the retractable refueling tube 160 and a flexible refueling tube 180. The connection portion 170 may be any acceptable means of coupling two fluid-carrying tubes. For example, a threaded connection may be used such that the flexible refueling tube 180 may have male or female threads on an end while the retractable refueling tube 160 would have the opposite of either male or female threads. The connection method could also be a push-pull type of quick connection apparatus such that the flexible refueling tube 180 could push onto the retractable refueling tube 160 for coupling. These connection methods would allow for the advantage of a quick connection of the flexible refueling tube 180 to the end of the retractable refueling tube 160 to facilitate maintenance, such as nozzle replacement, on the flexible refueling tube 180, or quick replacement of the flexible refueling tube 180 upon completion of its life cycle.

At the end of the flexible refueling tube 180 opposite to the connection portion 170, is a nozzle 190. The nozzle 190 permits the flexible refueling tube 180 to lock into the receiver aircraft 200 to transfer fuel to the receiver aircraft 200. The receiver aircraft 200 has a receiver area 215 that contains a nozzle receiver 210, also known as a nozzle dock, for securely receiving the nozzle 190. The flexible refueling tube 180 permits the nozzle 190 to remain in the nozzle receiver 210 even when the tanker aircraft 110 is moving vertically to the extent permissible according to the flexible limit of the flexible refueling tube 180. That is, an advantage of the flexible refueling tube 180 is that either the tanker aircraft 110 or the receiver aircraft 200 can move in a vertical plane while refueling is taking place without jeopardizing the integrity of the refueling operation. Furthermore, the tanker aircraft 110 may also move laterally, or horizontally, since the flexible refueling tube 180 permits movement in both planes. This is a significant advantage over prior art refueling booms that normally have very limited horizontal movement capabilities. Additionally, the flexible refueling tube 180 will permit movement from the nozzle receiver 210 location in nearly any direction. To elaborate, once the nozzle 190 is connected to the nozzle receiver 210, the tanker aircraft 110 is free to move laterally relative to the original longitudinal hook-up axis of the refueling boom 100. Finally, because the flexible refueling tube 180 is flexible, curvilinear motion of the tanker aircraft relative to the nozzle receiver 210 is also possible.

Although various directions of motion are permitted by the flexible refueling tube 180, one advantage of the flexible refueling tube 180 over existing refueling tubes is the ability of a boomer to visually witness the bending and subsequently eliminate the bending by flying the boom to a different position relative to the nozzle receiver 210. Because of such an advantage, the flexible refueling tube 180 also eliminates the need for sensors used in conjunction with a conventional automatic load alleviation system (ALAS) (not shown) on the tanker aircraft 110. An optional ALAS monitors stresses and loading in existing refueling booms during in flight refueling since such stresses and loading can not be accurately gauged by the naked eye by simply viewing a rigid tube.

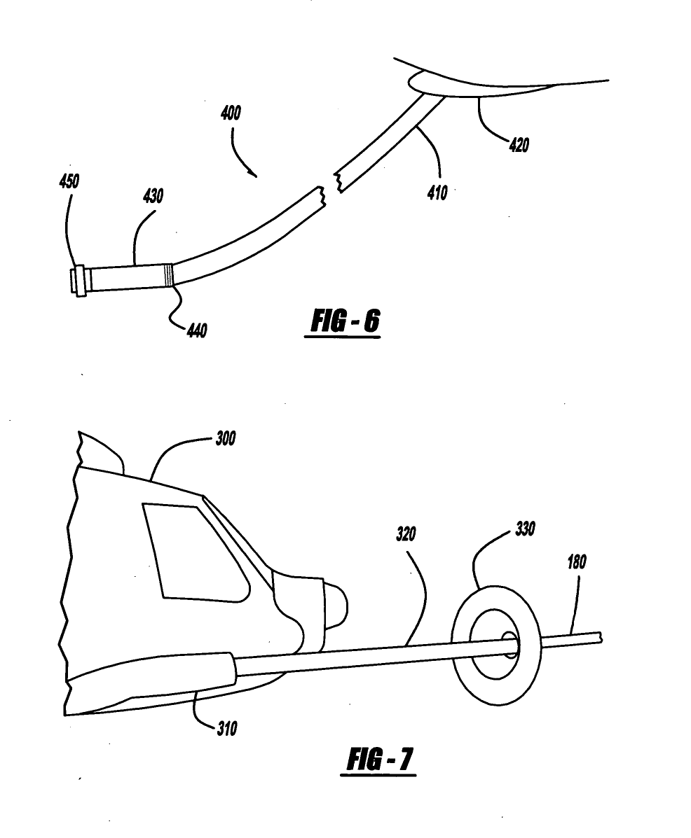

FIG. 3 depicts the flexible refueling tube 180 in a straight condition, while FIG. 4 depicts the flexible refueling tube 180 in a bent condition. FIG. 5 depicts the flexible refueling tube 180 in an expanded condition. FIG. 4 depicts the flexible nature of the flexible refueling tube 180 when it is placed under a load that is not coincident with the longitudinal axis of the flexible refueling tube 180. The flexible refueling tube 180 is permitted to flex in response to a situation in which the tanker aircraft 110 may move in a vertical plane, horizontal plane, or a combination of such, relative to the nozzle receiver 210. When the flexible refueling tube 180 is permitted to flex, nozzle loads and stresses are significantly reduced or eliminated.

FIG. 5 depicts the expansive nature of the flexible refueling tube 180, which illustrates another advantage of the present invention. An explanation of the pressure that the liquid aviation fuel creates in the boom tube will now be discussed. For all practical purposes, liquid fuel is not compressible and as a result, any energy that is applied to it is instantly transmitted to surrounding structure. This energy becomes dynamic in nature when a force such as a quick closing valve applies velocity to the fluid. Surge or “water hammer” is the result of a sudden change in liquid velocity. Water hammer usually occurs when a transfer system is quickly started, stopped or is forced to make a rapid change in direction. These events can cause undesired stresses to be placed on a liquid fuel transfer system such as an in-flight refueling boom. However, the flexible refueling tube 180 is designed to absorb the shock associated with any water hammer that occurs during an in-flight refueling operation.

When the fuel flow is shut off during refueling, the fuel pressure spike resulting from the momentum of the fuel mass is absorbed and reduced by the expansion of the flexible refueling tube 180. As depicted in FIG. 5, the flexible refueling tube 180 is seen in its expanded (i.e., albeit exaggerated) condition, while its unexpanded geometry is depicted in phantom at 230. Such an expansion occurs between the quick-connect threaded end 220, which connects to the retractable refueling tube 160, and the nozzle 190, which connects to the nozzle receiver 210. The primary cause of water hammer during in-flight refueling is by closing a fuel valve, whether manually or automatically. Such a fuel valve may be located at the aircraft, where the refueling boom 100 meets the aircraft 110, or at the nozzle receiver 210 of the receiver aircraft 200.

A fuel valve that quickly closes, depending upon valve size and system conditions, may cause an abrupt stoppage of fuel flow that generates a fuel pressure spike or acoustic wave in the refueling boom 100. The fuel pressure spike can be a multitude of times higher than the fuel system working pressure during steady-state refueling. The expandable, flexible refueling tube 180 will expand like a balloon in accordance with the pressure changes in such a re-fueling event when a valve is suddenly opened or closed, relative to the steady-state flow. For instance, steady-state refueling pressure is normally below 55 psi; however, the spike pressure in the refueling boom 100, which results when a valve is suddenly opened or closed, may approach 240 psi. The pressure at which the expandable, flexible refueling tube 180 may begin to expand may be just above 55 psi. Of course the actual fuel pressure at which the expandable, flexible tube 180 may begin to expand may vary with the material used for the expandable, flexible refueling tube 180.

When the fuel pressure exceeds 55 psi, for example, a boom operator will be able to visually witness the physical expansion of the expandable, flexible refueling tube 180. The expandable, flexible refueling tube 180 can be made of any rubber or rubber-like material that is suitable for the transfer of liquid aircraft fuel. As such, an advantage of the expandable, flexible tube 180 is the elimination of the need for a separate internal bladder that is typically used with existing refueling booms. This also eliminates the need to remove a traditional boom from an aircraft to replace such a bladder, and furthermore, permits quick and easy connection of a replacement expandable, flexible refueling tube 180 according to the present invention.

FIG. 6 depicts a second embodiment of the present invention. In the second embodiment, a refueling boom tube 400 is connected to the aircraft 420 and may entail an upper boom tube 410 and a lower boom tube 430. The lower boom tube 430 attaches to the upper boom tube 410 in one of several possible methods such as a threaded connection or a push-on pull-off type connection, or other suitable mechanical quick disconnect method. A nozzle 450 attaches to the lower boom tube 430 and is used in the same fashion as in the first embodiment, that is, the nozzle 450 is receivable by a nozzle receiver of an airborne mobile platform that is in need of refueling.

Continuing with reference to FIG. 6, the upper boom tube 410 may be made of a flexible, bendable material, such as rubber, that is suited to carrying liquid aviation fuel. Alternatively, the upper boom tube 410 may be made from a semi-rigid rubber. These upper and lower boom tubes 410, 430 may be made of the same rubber material or rubber materials having different rigidity and expansion characteristics. This is in contrast to the rigid upper boom tube 150 of the first embodiment which may be made of metal. Continuing, the lower boom tube 430 of the second embodiment may be a resilient rubber or rubber-like material that is capable of bending, expanding, and absorbing shock loads due to the fuel momentum pressure accumulation situation created in the lower boom tube 430 during the opening or closing of fuel valves during the refueling of an in-flight aircraft. The upper and lower boom tubes 410, 430 may be connectable by a quick connection joint 440, such as a threaded connection or push-on pull-off type connection. Thus, the lower boom tube 430 performs in the same manner as the expandable, flexible refueling tube 180 of the first embodiment.

A general advantage of the second embodiment is the total overall flexibility of the refueling boom tube 400 when the upper boom tube 410 is connected to the lower boom tube 430. Another advantage is that the refueling boom tube 400 gains even greater flexibility than existing boom tubes, and the refueling boom 10 of the first embodiment, because both sections of the refueling boom tube 400 are flexible. This permits greater variation in the relative positions of the airborne mobile platforms during a refueling operation.

FIG. 7 depicts a “capturing” or “basket” refueling system that receives fuel during refueling in a slightly different manner compared to the “lying boom” and nozzle system depicted in FIGS. 2 and 3. The teachings of the present invention may be used with either a nozzle receiver 210 or a basket type system. In the basket type system depicted in FIG. 7, a rotorcraft (e.g. helicopter) 300 extends a rigid refueling boom 320 from a refueling boom receptacle 310. The rigid refueling boom 320 has a refueling basket 330 that receives the extendable, flexible refueling tube 180, 430 according to the first and second embodiments. The alignment of the tanker aircraft need only be changed to accommodate such a refueling basket 330.

While various preferred embodiments have been described, those skilled in the art will recognize modifications or variations that might be made without departing from the inventive concept. The examples illustrate the invention and are not intended to limit it. Therefore, the description and claims should be interpreted liberally with only such limitation as is necessary in view of the pertinent prior art.

What is claimed is:

1. A refueling apparatus for an airborne mobile platform, comprising:
a first refueling tube in communication with a bottom side of the airborne mobile platform; and
a second refueling tube in communication with the first refueling tube, for communicating with a nozzle receiver of a receiver mobile platform, wherein at least one of said first and second tubes is flexible.

2. The refueling apparatus of claim 1, wherein the first refueling tube comprises a rigid tube.

3. The refueling apparatus of claim 1, wherein the first refueling tube comprises a flexible hose.

4. The refueling apparatus of claim 3, further comprising:
a nozzle attached to the second refueling tube, the nozzle being engageable with the nozzle receiver of the receiver mobile platform being refueled.

5. A refueling apparatus for a tanker aircraft, comprising:
an upper refueling boom tube connected to the aircraft;
a lower refueling boom tube connected to the upper refueling tube; and
a flexible refueling tube connected to the lower refueling boom tube.

6. The refueling apparatus of claim 5, further comprising:
a nozzle connected to the flexible refueling tube to facilitate refueling of a receiver aircraft.

7. The refueling apparatus of claim 5, further comprising:
a ruddevator attached to the upper boom tube to permit aerial control of the upper, lower and flexible tubes.

8. The refueling apparatus of claim 5, further comprising:
means for connecting the flexible tube to the lower boom tube.

9. The refueling apparatus of claim 5, wherein the lower refueling boom tube is retractable within the upper refueling boom tube during in-flight refueling.

10. The refueling apparatus of claim 5, further comprising:
a nozzle dock within a receiver aircraft for connecting to the nozzle during in-flight refueling.

11. The refueling apparatus of claim 5, wherein the flexible refueling tube permits vertical and lateral movement of the tanker aircraft relative to a receiver aircraft during in-flight refueling.

12. The refueling apparatus of claim 5, wherein the flexible refueling tube is expandable to absorb variances in fuel pressure.

13. The refueling apparatus of claim 5, wherein the upper refueling tube and the lower refueling tube are rigid.

14. A refueling aircraft, comprising:
a first rigid refueling tube attached to an underside of a fuselage of the aircraft;
a second rigid refueling tube retractably attached to the first refueling tube;
a third flexible refueling tube removably attached to the second rigid refueling tube, and retractable within the second rigid refueling tube.

15. The aircraft of claim 14, further comprising:
a nozzle, the nozzle being attached to an exit end of the third flexible refueling tube.

16. The aircraft of claim 15, further comprising:
means for attachment of the third flexible refueling tube to the second rigid refueling tube.

17. The aircraft of claim 16, further comprising:
at least one control vane, the control vane used to control the position of the nozzle during refueling.

18. The aircraft of claim 17, wherein the control vane is located along the first rigid refueling tube.
